(19) United States
(12) Patent Application Publication
(10) Pub. No.: US 2007/0219853 A1
(43) Pub. Date: Sep. 20, 2007

(54) Patent Examiner Selection

(75) Inventors: Andrew S. Van Luchene, Santa Fe, NM (US); Raymond J. Mueller, Palm Beach Gardens, FL (US); Dean Alderucci, Westport, CT (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, LLC, Santa Fe, NM (US)

(21) Appl. No.: 11/693,564

(22) Filed: Mar. 29, 2007

Related U.S. Application Data
(63) Continuation-in-part of application No. 11/627,263, filed on Jan. 25, 2007.
(63) Continuation-in-part of application No. 11/462,621, filed on Aug. 4, 2006.
(60) Provisional application No. 60/727,191, filed on Oct. 14, 2005.

(51) Int. Cl. H04M 3/51

(52) U.S. Cl. 705/11

(57) ABSTRACT

The present disclosure provides various novel means for selecting and assigning patent applications for examination. The disclosure describes various automated and non-automated means for selecting a qualified examiner based on a number of criteria including the examiner's history, current workload and the subject matter of the filed application. The disclosure further describes means for adjusting examiners workloads and ensuring the quality of examined applications.

### PRIORITY CLAIM

The following application is a continuation in part of U.S. patent application Ser. Nos. 11/627,263, filed Jan. 25, 2007 and Ser. No. 11/462,621, filed Aug. 4, 2006, which claims the benefit of U.S. Provisional Patent Application No. 60/727,191. Each of these applications is hereby incorporated by reference.

### BACKGROUND

Protecting intellectual property through patent systems is a vital part of most countries' national economies and well as the global economy. However, many patent systems are facing a number of challenges due to the increased technical complexity of patent applications as well as with the challenge of hiring and training new patent examiners to cope with the increasing number of applications being filed.

In 2000, 311,807 patent applications were filed in the U.S. This number increased to 409,532 applications in 2005. Globally, 145,300 applications were filed under the Patent Cooperation Treaty in 2006, representing a 6.4% growth over the previous year. This trend has held steady since 1995 with the number of applications filed increasing every year.

The problems in the protection of intellectual property rights are further compounded by virtual reality games. Hundreds of thousands of players access games known as massive multi-player online games (MMOGs) and massive multi-player online role playing games (MMORPGs). Players of these games customarily access a game repeatedly (for durations typically ranging from a few minutes to several days) over a given period of time, which may be days, weeks, months or even years. Many of these games purport to give intellectual property rights to the players in their virtual creations. However, these games lack a structured system for evaluating and granting such rights.

Given the increasing number of applications being filed and the increased demand for protection of intellectual property, it would be advantageous to provide alternate methods for assigning and distributing applications for examinations. Such alternate methods would relieve some of the pressure on patent systems, allowing examiner's to focus on the aspects of their duties that require human involvement.

### BRIEF DESCRIPTION OF THE DRAWINGS

FIG. 1 is a block diagram depicting a system 100 of an embodiment of the present invention.

FIG. 2 is an embodiment of a method of assigning an application to an examiner according to one embodiment of the application.

FIG. 3 is a block diagram depicting a system 200 of an embodiment of the present invention.

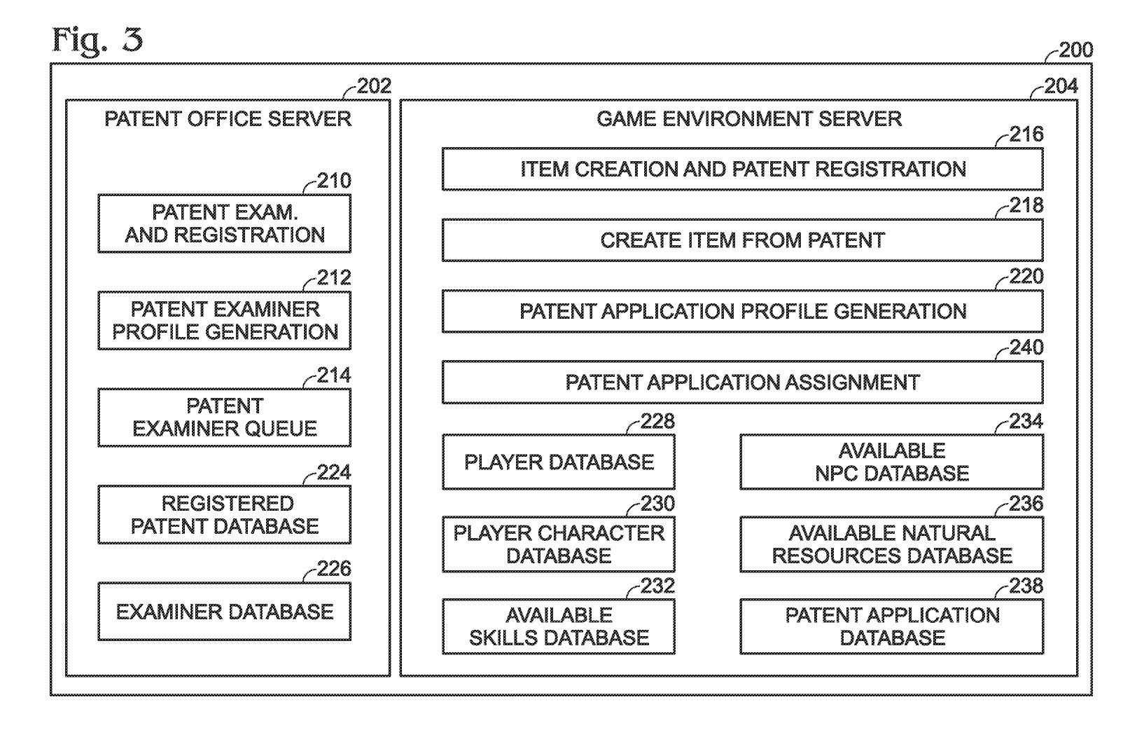

FIG. 4 is an embodiment of a method of a method of examining an application according to an embodiment of the invention.

### DETAILED DESCRIPTION

A patent is a means for protecting the rights of an inventor. It is a property right granted to an inventor by a governing entity or by a regional office or other third party acting for a governing entity or group of government entities. This right allows the inventor to exclude anyone else from commercially exploiting the inventor's invention for a set time period. What is granted is not the right to make, use, offer for sale, sell or import, but the right to exclude others from making, using, offering for sale, selling or importing the invention.

By granting an exclusive right patents provide incentives to individuals, offering them recognition for their creativity and material reward for their marketable inventions. These incentives encourage innovation. Due to the steady increase in the member of applications being filed, the burden on various patent offices has increased. This increase has resulted in delays in reviewing applications and increased workloads for examiners. There have been many efforts to streamline the patent application process, shorten examination times and ensure the quality of issued patents. However the sheer number of applications submitted can be overwhelming.

Various embodiments of the present invention address this issue by providing methods and systems for assigning applications to an examiner for examination. Such a system may be used to select the examiner with the most relevant expertise distribute workloads more evenly, evaluate efficiency and accuracy, as well as increase the resources available for evaluating applications and issued patents. These systems and methods may be used in the real world as well as in virtual worlds and provide a means for automating all or part of the selection process.

According to various embodiments:

Abstract of the Invention—includes that part of a patent application that is the abstract as defined by the USPTO guidelines.

Agent—includes the agent responsible for filing a patent application.

Alternate Language—includes words that can be used as alternates for words in a patent application.

Artificial Intelligence—includes any computer program that uses neural nets and genetic algorithms.

Assignee Name—includes the meaning defined by the USPTO guidelines.

Assignee City—includes the meaning defined by the USPTO guidelines.

Assignee State—includes the meaning defined by the USPTO guidelines.

Assignee Country—includes the meaning defined by the USPTO guidelines.

Attorney—includes the attorney responsible for drafting and/or filing a patent application.

Attorney Name—includes the meaning defined by the USPTO guidelines.

Attorney Address—includes the meaning defined by the USPTO guidelines.

Attorney State—includes the meaning defined by the USPTO guidelines.

Attorney Country—includes the meaning defined by the USPTO guidelines.

Background of the Invention—includes that part of a patent application that is background as defined by the USPTO guidelines.

Claims—includes that part of a patent application that is claims as defined by the USPTO guidelines.

Date Stamp—includes an electronic, unalterable stamp on an electronic file indicated the date that the file was created or received by a computer system.

Date of Invention—includes the date a patent application has with a first time stamp.

Degree of infringement—includes the statistically measured amount that a product or technical white paper infringes an issued patent application.

Description of the Invention—includes that part of a patent application that is description as defined by the USPTO guidelines.

Draftsperson—includes the meaning defined by the USPTO guidelines.

Dollar Value—includes a dollar amount that is defined as the value of a patent license of a patent.

End User—includes any user of a system including an inventor, researcher, attorney, or agent who is interacts with the system, e.g., by creating, enhancing, researching, filing, prosecuting, licensing, or invalidating a patent application. An end user may be required to be a member of a central system.

Electronic notification—includes an email or other means of digitally sending a message with a date and time stamp to an electronic address.

Errors and Omissions—includes the meaning defined by the USPTO guidelines

Examiner—includes a patent examiner.

Issued Patent—includes the meaning defined by the USPTO guidelines.

Filing Date—includes the time stamp of the date that a patent application was submitted to the patent office.

Filed Patent—includes a patent application that is filed with the USPTO.

File Wrapper—includes all files associated with a patent application including but not limited to: the patent application, a certified search, notes of distinguishing language, notes of rejection, notes of additional distinguishing language, record of interview, additional prior art references, and all electronic notifications associated with a patent application.

First Office Action—includes the meaning described in the USPTO guidelines.

Genetic Algorithm—includes a computer algorithm that is capable of modifying and improving itself over time.

Infringement—includes that a product or technical white paper practices the invention protected by the claims of an issued patent.

Interview—includes an electronically recorded conversation between an end user and a patent examiner.

Invention Class—includes the meaning described in the USPTO guidelines.

Invention Subclass—includes the meaning described in the USPTO guidelines.

Invention Figures—includes the meaning described in the USPTO guidelines.

Invention Claims—includes the meaning described in the USPTO guidelines.

Inventor Name—includes the meaning described in the USPTO guidelines.

Inventor City—includes the meaning described in the USPTO guidelines.

Inventor State—includes the meaning described in the USPTO guidelines.

Inventor Country—includes the meaning described in the USPTO guidelines.

Issued Patent—includes the meaning described in the USPTO guidelines.

Literature Prior Art—includes prior art for a patent application other than patents.

Missing Parts—includes the meaning described in the USPTO guidelines.

Non-Obviousness Score—includes a score given to a patent application by a central system that relates the obviousness of the invention disclosed by the patent application to prior art cited by the central system.

Notice of allowance—includes the meaning defined by the USPTO guidelines.

Notes—includes any language added to a prior art record by an end user.

Note of distinguishing language—includes notes provided by end users in response to the prior art cited in a certified search. These notes distinguish a patent application submitted by the end user over the prior art references contained in the certified search provided by the central system.

Note of additional distinguishing language—includes notes provided by end users in response to a second office action conducted by a patent examiner.

Note of rejection—includes the notes contained in a second office action provided by a patent examiner.

Novel—includes the meaning described in the USPTO guidelines.

Novelty Score—includes a score given to a patent application by a central system that related the novelty of the invention disclosed in the patent application to prior art cited by the central system.

Obvious—includes the meaning described in the USPTO guidelines.

Office Action—includes the meaning described in the USPTO guidelines.

Online Chat Room—includes any electronic correspondence medium that allows for a real time, electronic conversation between a patent examiner and an end user.

Patent Application—includes any document created to describe and invention by an end user.

Patent Application Data—includes data contained in a patent application.

Patent Application Date—includes the time stamped date that a patent application was entered into a central system.

Patent Examiner—includes a person responsible for reviewing the patent application and deciding if the patent can be issued.

Patent examination queue—includes the queue of patent applications that are assigned to a patent examiner that require office actions or reexaminations.

Patent invalidator—includes an end user who is attempting to invalidate an issued patent.

Patent License—includes a legal right to use an invention disclosed in an issued patent.

Patent Licensee—includes an end user who is licensing an issued patent.

Patent Office—includes the United State Patent and Trademark Office and any other Intellectual Property authority, virtual or real in this or any other world.

Patent Prior Art—includes prior art that is filed and issued patents.

Patent Value score—includes a score assigned by an artificial intelligence system that demonstrates the strength of the claims of an issued patent in light of prior art.

PCT Information—includes the meaning described in the USPTO guidelines.

Potential Licensee—includes an end user who may want to license an issued patent.

Prior Art—includes any document with a time stamp prior to the time stamp of a patent application.

Prior Art Data—includes data that is prior art.

Priority Date—includes the meaning described in the USPTO guidelines.

Product—includes a created thing that can be protected by or that can infringe the claims of an issued patent.

Published Prior Art—includes prior art that is available for review by the general public.

Reexamination—includes a second examination of a patent after it has been issued.

Relevance Score—includes a score assigned by an end user or by a central system to a particular piece of prior art as it relates to a particular patent application.

Research Report—includes a report assemble by a researcher or a central system that contains prior art related to a patent application.

Researcher—includes a person who manually researches prior art databases to find prior art related to a patent application.

Score—includes a numerical value assigned to something as it relates to something else.

Second Office Action—includes the meaning described in the USPTO guidelines.

Second examination—includes reexamination.

Status Change—includes a change in status of a patent application as it moves through the patent process. Changes in status can include but are not limited submitting the application for examination, receiving a certified search for the application, placing the patent application in an examiner queue, receiving an office action for the patent application, receiving a notice of allowance for the patent application, receiving a notice of missing parts for the patent application; receiving a patent number for the patent application, and receiving an indication of interest from a potential licensee for the patent application.

Submitted Patent Application—includes a patent application that an end user submits to the central system for examination.

Subsequent Patent Application—includes an application that comes after a patent application.

Technical white paper—includes a text description of a product that describes the parts of the product and how they work together.

Time Stamp—includes an unalterable recording of the time a document was created by, entered into, or received by a system.

Title—includes the meaning described in the USPTO guidelines.

Web-Based Application—includes an application that is accessible on the World Wide Web via a web browser such as Microsoft's Internet Explorer. The application will be stored on a central server and accessed via other computers.

Web-Based Form—includes an electronic form used to enter information by and end user into a web-based application.

Unpublished Prior Art—includes prior art that is not available to the general public, but that can be viewed by employees of the central system.

Useful—includes the meaning described in the USPTO guidelines.

Usefulness Score—includes a score given to a patent application based on its usefulness as defined by the USPTO guidelines.

Generally, patent applications are received by a patent office and then assigned to a technology center or other art group suited to that field. The applications are then classified and assigned to an examiner by a senior examiner or other reviewing entity. Given the increasing number of applications and the number of examiners working in the patent office, and the increasing specializing of particular technological fields, it may be difficult for a supervisor or other reviewing authority to retain the relevant details regarding the experience and history of all of the examiners.

Automating the process in whole or in part may streamline the application process, save examiners' time and increase productivity by allowing examiners to focus on higher value added activities such as examination or training rather than administrative tasks. Furthermore, spending large amounts of time on administrative duties such as assigning applications can erode skills, reduce efficiency and impair employee mentoring and development. Automating will increase the time available for other tasks, helping to address some of the issues such as a backlog of applications or delays in examination that are currently plaguing patent offices.

In some embodiments, a database may be created of all of the examiners and their histories. Such information may be used to create a profile of a patent examiner. This profile may be used to determine the examiner(s) with the most relevant experience in regards to each application received. Profiles may include information regarding previous applications that the examiner has examined, the patent applications in the examiner's queue for examination, the examiner's efficiency rating, the prior art cited in the previous and/or waiting applications, the examiner's education, the examiner's particular area of expertise, the length of time it takes the examiner to examine an application, the examiner's grade or level, the examiner's current workload, the examiner's seniority, the examiner's previous experience, the examiner's training, the number of reissues in previously filed applications, the number of appeals filed, the results of appealed applications, or any combination thereof.

In some embodiments, the elements of a profile may be assigned a number and a total score for an examiner may be generated. In some embodiments, the elements may be weighted. In further embodiments, the weighting of the elements may change depending on the use of the score. For example, the weighting may change depending on the information in the application. Some areas of technology may require more outside knowledge than others. In those instances, the examiner's previous education may carry more weight than other elements of a profile. In technology areas that require less specific knowledge, other elements of the profile may carry more weight. In some embodiments, the score generated may be a relevance score relating to the examiner's area of expertise in relation to a particular application.

When a new application is submitted to a patent office for examination, the field of invention, class, subclass, abstract, claims, or any combination thereof is reviewed for subject matter and an area of expertise for review is determined. Such a review may be run using a simple table based method, a rules based system, or artificial intelligence techniques, for example neural net, Bayesian algorithm, genetic algorithms, pattern recognition, expert systems, case based reasoning, fuzzy systems, hybrid intelligent systems, evolutionary computation, concept processing or any combination thereof.

In some embodiments, the submitted application is compared to the score generated by the patent examiner profile. Examiners whose profiles are comprised of those patent applications and prior art references that are most relevant to the patent application being submitted are given the highest relevance scores from the submitted patent application.

In other embodiments, the patent examiners with the highest relevance scores are then reviewed for workload. In some embodiments, workload is evaluated prior to determining relevance of experience. For example, examiners may not be eligible to receive an application for examination if the score they receive for their current workload is too high. Workload may be evaluated based on the number of applications the examiner is currently reviewing, the average length of time the examiner takes to process an application, the expected length of time to process a new application, or any combination thereof. In some embodiments, determinations may be made by the examiner, his peers or the public. In other embodiments, determinations may be made using artificial intelligence and genetic algorithms. In some embodiments, scores from different sources may be aggregated. Such an aggregation may or may not be weighted. In additional embodiments, the workload scores of examiners should be effectively equal. In order to address an imbalance or inequity, applications that are waiting to be examined may be reassigned. In additional embodiments, continued inequities in workloads may influence hiring decisions. For example, a supervisor may be notified if there is a continuing increase in applications in a particular area. Such notification may trigger a hiring listing or further investigation into the trend.

The examiner with the most closely related relevance score and the workload score indicating the most availability may then be assigned the application. In some embodiments, the comparison of the relevance score and workload score may be weighted. In other embodiments, for example in particularly specialized fields, the workload score may be disregarded.

In some embodiments, the system may be designed to receive feedback. Such feedback may be used to increase the accuracy of the assignment and the weighting of the scoring. For example, the assigned examiner may submit their time estimate for reviewing the application. This time estimate may be shorter or longer than that calculated by the system. In another embodiment, the examiner could determine that he or she does not have the necessary expertise in the field of the application and may request reassignment of the application. Such feedback could be incorporated into the algorithm to add to the efficiency of the system. Feedback may be used to continuously update the system, update it periodically, or may be used as part of a multivariate or regression analysis to alter the way information is processed.

In a further embodiment, patent applications and/or office actions may be reviewed by a peer or other third party. For example, a patent attorney that is unaffiliated with a particular case could review an examiner's work and provide feedback in the form of a numeric score and/or comments. Applications could be assigned to patent attorneys who volunteer for such service, or all patent attorneys may be required to review a set number of applications in a specific time period. In some embodiments, the patent attorneys who provide such services may be compensated. Such compensation may be payment of a fee, reduction of patent office fees for the applications that patent attorney files, acceleration of examination for that patent attorney's applications, or any combination thereof.

In additional embodiments an issued patent may be submitted for review by a potential licensee or patent invalidator. Such a request may provide assurance for the licensee as to the validity and/or strength of a particular patent.

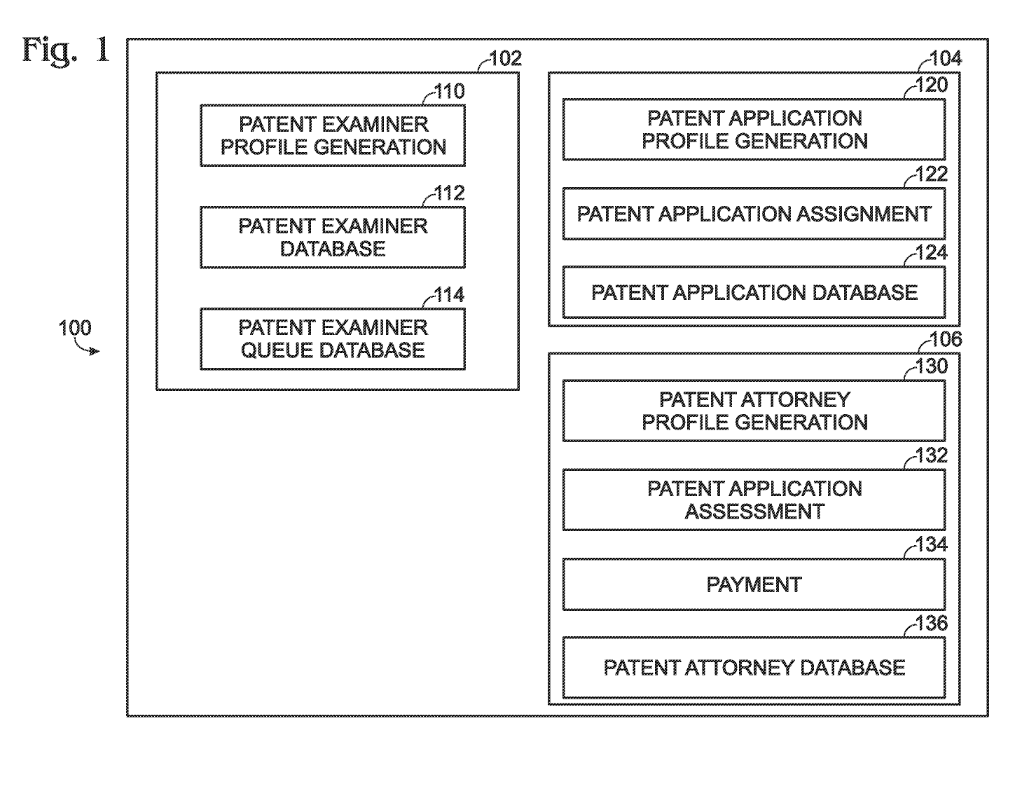

FIG. 1 provides an exemplary system 100 that may be used to provide the embodiment described above. As shown, system 100 may include examiner server 102, Application server 104 and Patent attorney server 106.

Examiner server 102 may include programs such as patent examiner profile generation programs 110, and various associated databases such as patent examiner database 112, and patent examiner queue 114.

Application server 104 may include programs such as patent application profile generation program 120 and patent application assignment program 122 as well as databases such as patent application database 124.

Patent attorney server 106 may include programs such as patent attorney profile generation program 130, patent application assignment program 132 and payment program 134 as well as patent attorney database 136.

Applications for examination, whether initial examination or subsequent review, may be submitted by any means possible. In some embodiments, applications may be submitted electronically. In other embodiments, applications may be submitted on paper. In a further embodiment, applications may be submitted by facsimile. All applications may be assigned using the system described above, or such a system may be used for particular classes of applications.

Information regarding applications and/or the application themselves may be stored, for example, in patent application database 124. Such a database may include information such as application ID, application data, certified search ID, distinguishing language data, application class, application subclass, end user ID, file date, application score, application length, and application claims.

Once submitted, a profile of the application may be generated, for example using patent application profile generation program 120. A profile score for a patent application may be calculated, for example, using some or all of the following steps:
1. Receive patent application.
2. generate score for patent application based on patent application data.
3. store patent application score.

The profile for an application may then be compared to the profile for an examiner. Information regarding examiners may be stored, by any means applicable, for example in patent examiner database 112. Patent examiner database 112 may include information such as, but not limited to, patent examiner history which may include information such as, examiner ID, examiner profile, examiner work load, previous examinations, examiner education, examiner experience, examiner training and examiner score.

A profile for an examiner may be calculated, for example, using patent examiner profile generation program 110. Patent examiner profile generation program 110 may be configured, for example, to use some or all of the following steps:
1. retrieve patent examiner history.
2. retrieve patent applications previously examined by examiner.
3. generate a score for patent examiner based on applications previously examined by examiner and patent examiner history.
4. store patent examiner score.

Once the profile for an examiner has been compiled, the scores of a patent application and the examiner may be compared to locate the examiner with the most relevant experience. An application may be assigned to an examiner using a program such as patent application assignment program 122. Such a program may, for example, be configured to use some or all of the following steps:
1. retrieve patent application score.
2. generate list of patent examiners with scores closest to patent application
3. assign patent application to patent examiner based on score.

In some embodiments, the current workload of an examiner may be taken into consideration. Such information may be stored, for example in patent examiner queue database 114. Patent examiner queue database 114 may include information such as examiner ID, application ID 1-N, target completion date 1-N, priority fee 1-N, queue score. The current workload of an examiner may be taken into consideration using, for example, some or all of the following steps:
1. Retrieve patent application score.
2. Generate list of patent examiners with scores closest to patent application
3. Retrieve patent examiner queue scores.
4. Assign patent application to patent examiner based on score and queue score.

In other embodiments, workload may be taken into consideration prior to the selection of examiners with the closes relevance scores. For example, using some or all of the following steps:
1. Calculate examiner queue score.
2. Retrieve patent application score.
3. Retrieve patent examiner relevance scores.
4. Disregard examiners with highest queue score.
5. Assign application to examiner with closest remaining relevance score.

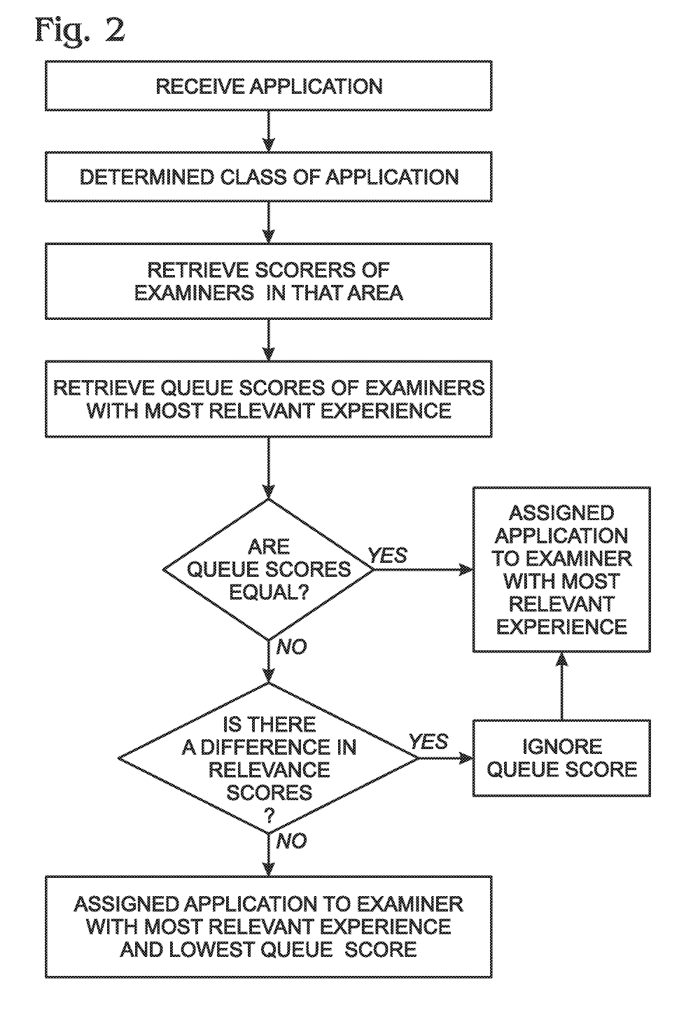

In one embodiment, an application may be assigned to an examiner using some or all of the steps in FIG. 2 wherein when an application is received its class is determined. Once the class is determined, the profiles of examiners in that field are accessed and the relevance scores of those examiners are retrieved. The examiners with the most relevant experience are determined and their queue scores are retrieved. If the examiners have comparable workloads, the queue scores are ignored. If the examiners have differing queue scores, the application is assigned to the examiner with the lowest queue score and the most relevant experience unless there is a significant difference in the relevance scores in which case the queue scores may be disregarded.

In some embodiments, examination of an application may benefit from collaboration. Such a collaborative system may add to the strength of issued patents by providing additional insight and critique. Examined applications may be reviewed by a peer or a third party at any point during the examination process. In some embodiments, an application may be reviewed, initial comments made and the application reassigned to a second examiner for additional input. In other embodiments, an application may be reviewed just prior to issuance of a notice of allowance. In a further embodiment, issued patents may be reviewed and subject to recall during a specific time period, for example during the first six months or the first five years after issuance.

Additional review may be performed by another examiner or an outside party such as a patent attorney. Some patent attorneys may focus their practice entirely on the review of filed applications or may do so in conjunction to their own practice. A profile of each patent attorney willing to review applications may be compiled, for example, in patent attorney database 136. Patent attorney database 136 may include information such as, but not limited to, patent attorney ID, patent attorney profile, applications profiled, experience, education, years in practice, patent attorney score, previous applications reviewed, timeliness of review, conflicts, current clients, firm affiliation, or any additional information considered relevant to assigning an application to a particular patent attorney.

A profile for a patent attorney may be calculated, for example, using patent attorney profile generation program 130. Patent attorney profile generation program 130 may be configured, for example, to use some or all of the following steps:
1. Retrieve patent attorney record.
2. Retrieve applications previously filed by patent attorney.
3. Retrieve patent applications previously examined by patent attorney.
4. Generate a score for patent attorney based on applications previously examined and previously filed by patent attorney.
5. Store patent attorney score.

Once a patent attorney profile score is generated, it may be compared to the score of a particular application. Patent attorneys with the most relevant score may then be assigned an application for review using, for example, patent application assignment program 132.

In some embodiments, patent attorneys may receive remuneration for applications they review. Remuneration may include payment of a fee, reduction of patent office fees, acceleration of examination of pending applications, or any combination thereof. In other embodiments, review of a certain number of applications in a specific time period may be mandatory. In further embodiments, review may be voluntary. Information regarding the payments received or the type or amount of payment may be calculated, for example, using payment program 134.

Protection of intellectual property is becoming increasingly important in virtual worlds as well as in the real world. Massive multi player online games (MMOGs) or massive multi-player role-playing games (MMORPGs) are computer game which are capable of supporting hundreds, thousands, or millions of players simultaneously. Typically, this type of game is played in a giant persistent world where the game continues playing regardless of whether or not real players are logged in. Players commonly access these games through a network such as the Internet, and may or may not be required to purchase additional software or hardware in order to play the game. Such networks allow for people all over the world to participate and interact with each other in a virtual environment.

Individuals involved in playing and participating in virtual environments spend a great deal of time and energy developing and executing ideas, concepts, and designs to be used in a virtual environment. Some games give intellectual property rights in the concepts, designs or ideas in a virtual environment, however these games generally lack a systematic system for registering such concepts, designs or ideas.

FIG. 2 provides an exemplary system 200 that may be used to register virtual ideas, concepts and designs as described above. As shown, system 200 may include a patent office server 202, and a game environment server 204.

Patent Office Server 202 may include patent examination and registration program 210, and patent examiner profile generation program 212. Patent Office Server 202 may further include a plurality of databases such as registered patent database 224, a patent examiner queue database 214, and examiner database 226.

Game environment server 204 may include programs such as item creation and patent registration program 216, create item from patent program 218, patent application profile generation program 220 and patent application assignment program 240 as well as various databases such as player database 228, player character database 230, available skills database 232, available NPC database 234, available natural resources database 236, and patent application database 238.

Patents may be used as blueprints for the design and building of any object to be used in a virtual environment. In some embodiments, the types of patents that may be registered and the type of virtual objects that may be built may depend in part on the virtual environment in which the character resides. Each design for a virtual object may generate one or more patents. Patents may contain all or some of the design elements of a concept or may contain a general outline of the object sought to be replicated. In some embodiments, patents may be based on a combination of digital images, information from the design database, other blueprints, and/or computer readable code.

Each patent application created may be stored, for example, in patent application database 238, which may include information such as creator, game environments in which it may be used, ID, assignee, class, status, content, registration date, expiration date, number of times used, allowable quantity, skills needed, import and export restrictions, and materials needed. Once an application is examiner and registered, it may be stored, for example in registered patent database 224. Registered patent database 224 may include, for example, creator, licensing structure, royalty payments, valuation, game environments in which it may be used, game environments in which it has been used, ID, assignee, class, status, content, registration date, expiration date, number of times used, allowable quantity, skills needed, import and export restrictions, and materials needed

The registration of a patent application may require examination of the patent application in order to determine that it does not infringe anyone else's patent, and/or to verify that it does not infringe any virtual or real world patents, registrations, copyrights or trademarks. Such an examination may occur by any means applicable, for example through a governing entity or through a patent office. In one embodiment, a patent may be analyzed using various rules based expert systems or genetic algorithms to determine the degree of difference between one design and another. If the degree of difference is not of an adequate percentage, the patent application can be rejected by the patent office system of the game server. Such an analysis may take place, for example, using patent examination and registration program 210.

In another embodiment, system 200 may be configured to determine if an application can be registered by performing steps such as:
1. Receive an application filing, including player character inventor ID, virtual entity assignee ID, application design, application class and subclass, required resources and skills to assemble the invention in the application, and required other patents to assemble the invention.
2. Compare filed application to existing patents and generate a similarity rating.
3. If similarity rating is greater than allowable threshold, flag application as requiring further examination.
4. If similarity rating is less than allowable threshold, generate a registration number.
5. Assign registration number to application record.
6. Notify owner that application has been registered.
7. Post application in patent office.

If the system is unable to make a determination as to the originality of an application, a determination may be made by players, characters, or other third parties.

In another embodiment, examination is performed by an examiner. In one embodiment, examiners are hired and governed by laws and rules, such as the laws and rules of the United States of America, the USPTO, Paris Convention for the Protection of Industrial Property, European Patent Convention, European Patent Office, Japan Patent Office, World Intellectual Property Organization, African Regional Intellectual Property Organization, Canadian Intellectual Property Office, Eurasian Patent Organization, European Patent Office, German Patent Office, Indian Patent Office, IP Australia, Japan Patent Office, Organisation Africaine de la Propriete Intellectuelle, Irish Patent Office, State Intellectual Property Office of China, Intellectual Property Office of Taiwan, Intellectual Property Office of Singapore, Intellectual Property Office of Philippines, United Kingdom Patent Office or by laws, rules and regulations established by the game manufacturer, one or more players in the game designated for such purpose, any other body elected by the players and/or appointed by the game manufacturer, and/or any other entity that is duly authorized to appoint and/or hire examiners.

In some embodiments, the role of examiner may be performed by NPCs. In other embodiments, examiners may be other characters. In a further embodiment, examiners may be players. According to one embodiment, a virtual or real fee can be charged to a player character who wants to register an application. Such fees may be fixed or variable or fixed and variable at different points in the game and may be determined arbitrarily, based on the resources needed to make the object in the application, the complexity of the application, the number of applications the character has previously registered, the availability of examiners, the backlog for registration and/or examination, market prices, real world examination fees, or any combination thereof. In some embodiments, there may be fees paid to accelerate examination. A portion of this fee can be paid to other player characters who are willing to examine the filed application for registerability. In another embodiment, examiners can be volunteers.

Once submitted, a profile of the application may be generated, for example using patent application profile generation program 220. A profile score for a patent application may be calculated, for example, using some or all of the following steps:
1. Receive patent application.
2. Generate score for patent application based on patent application data.
3. Store patent application score.

The profile for an application may then be compared to the profile for an examiner. Information regarding examiners may be stored, by any means applicable, for example in patent examiner database 226. Patent examiner database 226 may include information such as, a patent examiner history which may include information such as, but not limited to, examiner ID, examiner profile, examiner work load, previous examinations, examiner ID, examiner class, examiner skills, examiner qualifications, examiner subclass, examiner education, examiner experience, and examiner score.

A profile for an examiner may be calculated, for example, using patent examiner profile generation program 212. Patent examiner profile generation program 212 may be configured, for example, to generate a profile using some or all of the following steps:
1. Retrieve patent examiner history.
2. Retrieve patent applications previously examined by examiner.
3. Generate a score for patent examiner based on applications previously examined by examiner.
4. Store patent examiner score.

Once the profile for an examiner has been compiled, the scores of a patent application and the examiner may be compared to locate the examiner with the most relevant experience. An application may be assigned to an examiner, for example, using some or all of the following steps:
1. Retrieve patent application score.
2. Generate list of patent examiners with scores closest to patent application
3. Assign patent application to patent examiner based on score.

In some embodiments, the current workload of an examiner may be taken into consideration. Such information may be stored, for example in patent examiner queue database 214. Patent examiner queue database 214 may include information such as examiner ID, application ID 1-N, target completion date 1-N, priority fee 1-N, queue score. The current workload of an examiner may be taken into consideration using some or all of the following steps:
1. Retrieve patent application score.
2. Generate list of patent examiners with scores closest to patent application
3. Retrieve patent examiner queue scores.
4. Assign patent application to patent examiner based on score and queue score

A patent application may be assigned to an examiner using a combination of the relevance score and the queue score, or just the relevance score or just the queue score. In some embodiments, applications may be reassigned if an examiner's queue score gets too high. Assignment of an application to a particular examiner may take place using, fur example, patent application assignment program 240.

Once assigned, an application may be examined. In some embodiments, examination may take place using a combination of examiners and algorithms. For example, the server may select the most closely related patents and present them to an examiner for the final determination regarding registerability. Such a method may use some or all of the following steps:
1. Output a patent that has a similarity rating higher than allowable threshold to a player character.
2. Receive opinion from player character that application can be registered.
3. Generate a registration number.
4. Assign registration number to blueprint record.
5. Notify application owner that application has been registered.
6. Post application in patent office.

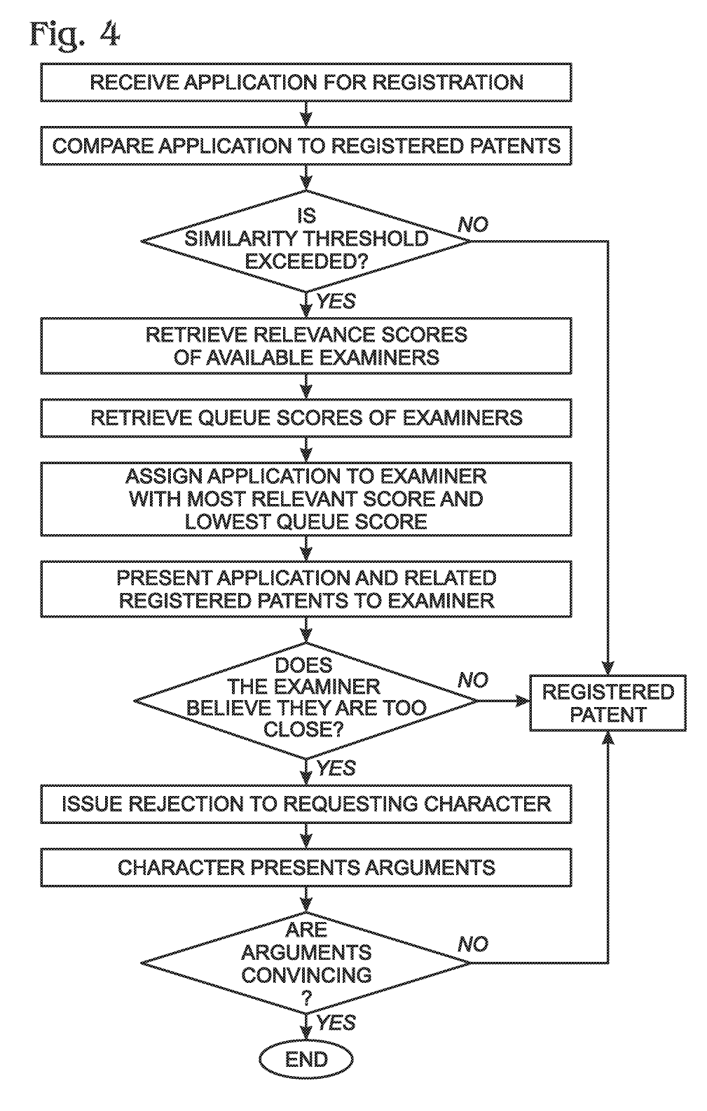

In another embodiment, examination may occur using a method such as that outlined in FIG. 4 where an initial screening is made comparing an application to registered patents. If the threshold of similarity is not exceeded, the application is registered. If the threshold is exceeded, an examiner is selected to review the application and the application to be registered and the similar patents(s) are given to an examiner to the selected examiner. If the examiner disagrees with the assessment, the examiner may register the application. If the examiner agrees with the assessment that the application and patents are too closely related, a rejection may be sent to the creator or other character seeking to register the application. The creator or other character seeking to register the application may then present arguments regarding the differences between the application and patents. If the examiner is convinced, the application may be registered. If the examiner is not convinced, registration may be denied.

Patents may be used to create virtual objects in the virtual environment. In some embodiments only registered patents may be used. In other embodiments, there may be ways around the registration requirement. In some embodiments, only the creator of the patent or characters designated by the creator of the patent may request objects be made using the patent. When a request is made to construct a virtual object, the requesting character's assets may be inventoried to determine if they possess the necessary materials and skills to make the requested virtual object. In some embodiments, players and/or characters may need to have particular types of accounts in order to assemble objects from patents. Information regarding the character and the player controlling the character may be stored, for example in player database 228 and player character database 230, respectively. Player database 228 may include information such as, but not limited to, player ID, the character(s) controlled by the player, blueprints imported, design concepts, objects created, billing information, account information and personal information. Player character database 230 may include information such as, but not limited to, character ID, player ID, assets, skills, obligations, objects created, objects requested, raw materials, natural resources, attributes, rates for use of skills, patents invented, patents owned, and game environment access.

If they do not have the necessary materials, the name of a supplier may be requested or proffered In some embodiments, virtual objects may only be constructed with natural resources and raw materials that are found in that game environment. In other embodiments, additional natural resources and raw materials may be brought in from other game environments. Information regarding natural resources and raw materials may be stored, for example in available natural resources database 236. Available natural resources database 236 may include information such as, but not limited to, resource ID, resource descriptor, last market value, maximum allowed, issued to date, remaining to be issued, permit price, available date range, renewability, and resource attributes 1-n.

Characters may also be inventoried to determine if they have the necessary skills to construct a virtual object. If they do not have the necessary skills, the requesting character may request the game server, an NPC or another character assemble the object. Information regarding the skills and NPCs available in a particular environment may be stored for example, in skill database 232 and NPC database 234 respectively. Skill database 232 which may contain information such as the skill ID, type, conditions for use, available era(s), characters with skills, NPCs with skills, skill levels, and use of skills. NPC database 234 may include information such as NPC ID, type, location, conditions for use, license or permit fee, available eras, costs for use, and skills. In some embodiment, the particular characters or NPCs with the necessary skills may not exist in that game environment.

Once the necessary patents, materials, skills and NPCs are acquired, an object may need to be assembled. Assembly may take place using any means applicable, for example item creation and patent registration program 216. In one embodiment, a character may only be able to request the formation of virtual objects that they have the ability to assemble. In another embodiment, a player character may only be able to request the formation of virtual objects that they can use. In a further embodiment a player character may request the formation of any virtual object. Virtual objects may be created by any means applicable. For example, in one embodiment, virtual objects may be created using create item from patent program 218.

It will be appreciated that while, for the sake of discussion, various databases have been described separately, the data in these and any other suitable databases could be merged into a single large databases and/or maintained separately in additional databases, or in other structures besides a database. Moreover, any such databases could be independent or linked, and the data in these databases could be stored centrally on a server or separately on game devices.

The present disclosure provides numerous systems and methods related to examination systems for real world patent systems as well as patent systems in virtual environments in online computer games. It should be appreciated that numerous embodiments are described in detail and that various combinations and subcombinations of these embodiments are contemplated by the present disclosure.

A reference to “another embodiment” in describing an embodiment does not necessarily imply that the referenced embodiment is mutually exclusive with another embodiment (e.g., an embodiment described before the referenced embodiment), unless expressly specified otherwise.

The terms “include”, “includes”, “including”, “comprising” and variations thereof mean “including but not limited to”, unless expressly specified otherwise.

The term “consisting of” and variations thereof includes “including and limited to”, unless expressly specified otherwise. The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The terms “such as”, “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” may include one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” includes any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the environment described herein.

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. §1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

We claim:

1. A method of selecting the appropriate examiner to examine a patent application comprising:
a) determining a profile for a patent examiner;
b) determining a profile for the subject matter of a patent application;
c) assigning the examiner with the closest profile to the profile of the subject matter of a patent application to examine the application.

2. The method of claim 1 further comprising evaluating the current workload of the most appropriate examiners and assigning the application to the examiner with the least workload.

3. The method of claim 2, wherein evaluating the current workload comprises:
a) determining the amount of time it will take an examiner to examine the application;
b) determining the number of pending applications in the examiner's queue;
c) determining the amount of time required to examine the pending applications; and
d) creating a queue score based on the number of applications.

4. The method of claim 1, wherein determining a profile for a patent examiner comprises:
a) retrieving a patent examiner history;
b) retrieving the patent applications previously examined by the examiner;
c) generating a score for an examiner based on applications previously examined by the examiner.

5. The method of claim 4, wherein determining a profile for a patent examiner further comprises retrieving the number of applications that have been appealed.

6. The method of claim 4, wherein a patent examiner history comprises the patent examiner's education, seniority, number of applications examined, and training.

7. The method of claim 4, wherein the score is generated using artificial intelligence techniques.

8. The method of claim 7, wherein the artificial intelligence techniques are neural net, Bayesian algorithm, genetic algorithms, pattern recognition, expert systems, case based reasoning, fuzzy systems, hybrid intelligent systems, evolutionary computation, or concept processing.

9. The method of claim 1, wherein determining a profile for the subject matter of a patent application comprises:
a) evaluating the field of the invention;
b) evaluating the class of the invention;
c) evaluating the abstract of the invention;
d) evaluating the claims of the invention;
e) generating a score for the application based on the evaluation.

10. The method of claim 9, wherein the evaluation is made using artificial intelligence techniques.

11. The method of claim 10, wherein the artificial intelligence techniques are neural net, Bayesian algorithm, genetic algorithms, pattern recognition, expert systems, case based reasoning, fuzzy systems, hybrid intelligent systems, evolutionary computation, or concept processing.

12. The method of claim 1, wherein the patent is submitted in electronic format.

13. The method of claim 1, wherein the examiner assigned an application can request that it be reassigned.

14. A method for adjusting examiner workload comprising:
a) determining the length of time it should take to examine an application;
b) reviewing the number of applications waiting in a queue to be examined by a particular examiner;
c) determining the length of time it should take to examine the applications in the examiner's queue;
d) generating a queue score based on the length of time to examine applications and the number of applications waiting in a queue;
e) comparing the queue scores of examiner's in a technology center;
f) reassigning applications so that all examiner's queue scores are approximately equal.

15. The method of claim 14, wherein the determination of the length of time it should take to examine an application is determined using artificial intelligence.

16. The method of claim 14, wherein a supervisor may reassign applications.

17. The method of claim 14, wherein applications are reassigned automatically.

18. The method of claim 14, wherein applications are reassigned based on an examiner's relevance score.

19. The method of claim 18, wherein an examiner's relevance score is determined by:
a) retrieving a patent examiner profile;
b) retrieving the patent applications previously examined by the examiner;
c) generating a score for an examiner based on applications previously examined by the examiner.

20. The method of claim 14, wherein when the queue scores of the examiner's in a particular technology center reach a particular threshold, a job listing for additional examiners is posted.
